(19) United States
(12) Patent Application Publication
(10) Pub. No.: US 2012/0295150 A1
(43) Pub. Date: Nov. 22, 2012

(54) BATTERY MODULE AND METHOD OF MANUFACTURING THE SAME

(75) Inventors: Dalong Gao, Rochester, MI (US); John Patrick Spicer, Plymouth, MI (US)

(73) Assignee: GM GLOBAL TECHNOLOGY OPERATIONS LLC, Detroit, MI (US)

(21) Appl. No.: 13/109,054

(22) Filed: May 17, 2011

(51) Int. Cl. H01M 2/26; H01M 10/04; H01M 6/42

(52) U.S. Cl. 429/158; 29/623.1; 29/525.01

(57) ABSTRACT

A battery module includes a plurality of stacked electrochemical battery cells, each having a positive cell tab and a negative cell tab. The positive cell tabs and the negative cell tabs are electrically connected through an interconnecting member. The interconnecting member includes a substrate supporting a plurality of connecting elements and defining a first slot and a second slot adjacent each of the connecting elements. The tabs of the electrochemical battery cells extend through the slots and are bent into a parallel relationship relative to the connecting elements. A fastening mechanism, such as a rivet, a bolt a screw, a clip or a weld, fastens the tabs to their respective connecting element.

### TECHNICAL FIELD

The invention generally relates to a battery module, and a method of manufacturing the battery module. The battery module includes a prismatic stack-type battery module for a battery pack.

### BACKGROUND

Batteries are useful for converting chemical energy into electrical energy, and may be rechargeable or non-rechargeable. Rechargeable batteries may be useful for a wide range of applications, such as powering electronic devices, tools, machinery, and vehicles. For example, rechargeable batteries for vehicle applications may be recharged external to the vehicle via a conventional plug-in electrical outlet, or onboard the vehicle via a regenerative event.

Although primary alkaline, voltaic pile, and lead-acid batteries have been used in numerous household and industrial applications, nickel cadmium (NiCd), nickel-metal hydride (Ni-MH), lithium ion, and lithium ion polymer rechargeable batteries may be particularly useful for emerging electric and hybrid gas/electric vehicle applications. That is, such rechargeable batteries often exhibit superior energy densities as compared to conventional non-rechargeable batteries. Further, rechargeable batteries may be constructed without a rigid and heavy outer metal battery casing, and may therefore be useful for applications requiring reduced battery size and weight.

A battery, which also may be known as a battery pack, may include one or more battery modules. Similarly, a battery module may include one or more electrochemical battery cells positioned adjacent to each other, e.g., stacked. Further, each electrochemical battery cell may include foil cell tabs that function as conductive terminals. The cell tabs of the electrochemical battery cells may be joined together in a manner suitable for completing an electrical circuit of the battery module.

### SUMMARY

A battery module is provided. The battery module includes a plurality of electrochemical battery cells positioned adjacent each other. Each of the electrochemical battery cells includes a positive cell tab and a negative cell tab. An interconnecting member is coupled to each of the electrochemical battery cells. The interconnecting member is configured for electrically connecting all of the positive cell tabs, and is also configured for electrically connecting all of the negative cell tabs. The interconnecting member includes a plurality of connecting elements, and defines a first slot and a second slot disposed adjacent opposing sides of each connecting element. At least one positive cell tab or one negative cell tab extends through each of the first slots and the second slots and is formed into a parallel relationship relative to the connecting element adjacent thereto. A plurality of fastening mechanisms connect the positive cell tabs and the negative cell tabs to one of the connecting elements.

A method of manufacturing a battery module is also provided. The method includes stacking a plurality of electrochemical battery cells adjacent each other. Each of the electrochemical battery cells includes a positive cell tab and a negative cell tab. An interconnecting member is positioned adjacent the stacked electrochemical battery cells so that each of the positive cell tabs and each of the negative cell tabs extend through one of a first slot or a second slot disposed adjacent one of a plurality of connecting elements. Each of the cell tabs is formed until approximately parallel with adjacent to the connecting element disposed adjacent the slot through which each tab is extended through. Each of the positive cell tabs and the negative cell tabs is fastened to one of the connecting elements.

Accordingly, because the tabs are formed, e.g., bent, until approximately parallel with the connecting elements, the tabs may be mechanically fastened from above, i.e., from a direction substantially perpendicular to the interconnecting member, through a single sided connection process. Furthermore, if the tabs extending through the slots adjacent each connecting element are formed to overlap each other, the number of connections required to connect the tabs to the interconnecting element is reduced.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a battery pack and components thereof, including a plurality of electrochemical battery cells and a plurality of battery modules.

FIG. 2 is a schematic perspective view of a portion of a battery module showing a plurality of electrochemical battery cells coupled to a connecting element.

FIG. 3 is a schematic cross sectional view of the battery module.

FIG. 4 is a schematic plan view of an electrochemical battery cell perpendicular to a longitudinal axis of the battery module.

FIG. 5 is a schematic plan view of an interconnecting member of the battery module parallel to the longitudinal axis.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

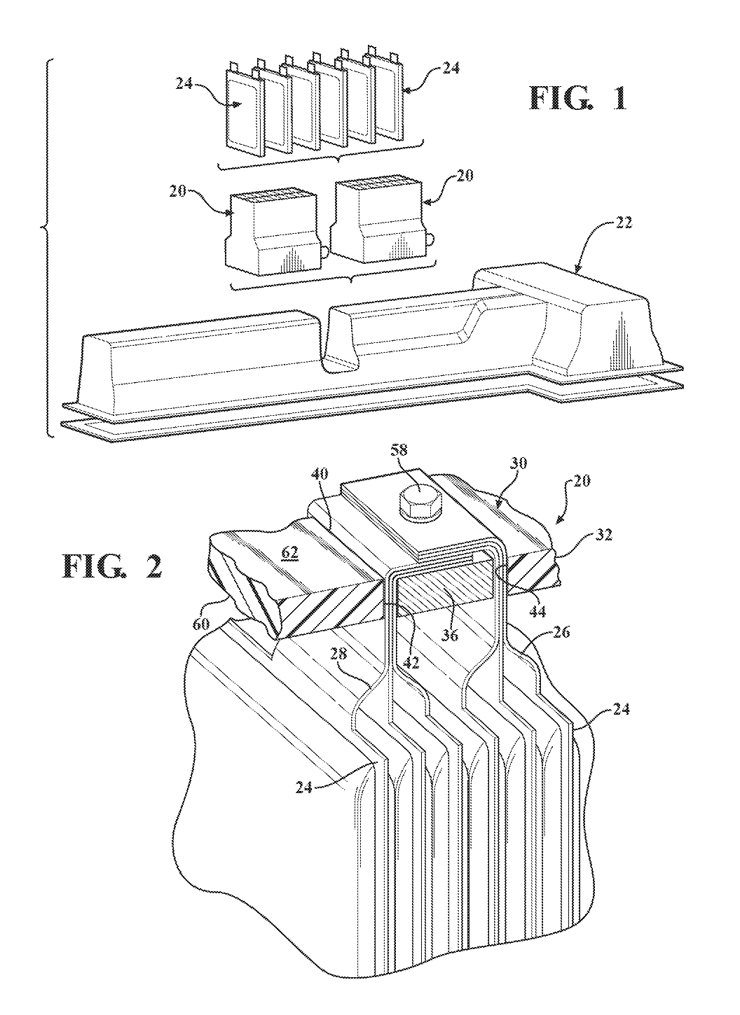

Referring to the Figures, wherein like reference numerals refer to like components, a battery module is shown generally at 20 in FIG. 1. The battery module 20 may be useful for automotive applications, such as for a plug-in hybrid electric vehicle (PHEV). For example, the battery module 20 may be a lithium-ion polymer battery module 20. Referring to FIG. 1, a plurality of battery modules 20 may be combined to form a battery pack 22. By way of example, the battery pack 22 may be sufficiently sized to provide a necessary voltage for powering a hybrid electric vehicle (HEV), an electric vehicle (EV), a plug-in hybrid electric vehicle (PHEV), and the like, e.g., approximately 300 to 400 volts or more, depending on the required application. However, it is to be appreciated that the battery module 20 may also be useful for non-automotive applications, such as, but not limited to, household or industrial tools, recreational vehicles, and electronic devices.

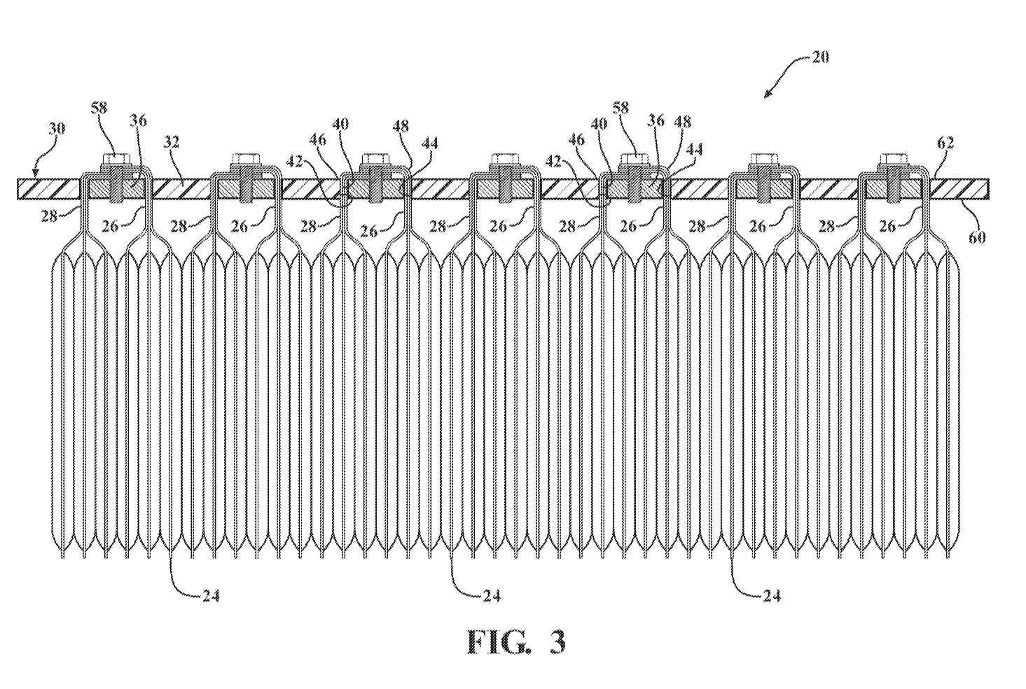

Referring to FIGS. 2 and 3, the battery module 20 includes a plurality of electrochemical battery cells 24 positioned adjacent one another. The electrochemical battery cells 24 may include any suitable electrochemical battery cell 24 known in the art. For example, the electrochemical battery cell 24 may be lithium ion, lithium ion polymer, lithium iron phosphate, lithium vanadium pentoxide, lithium copper chloride, lithium manganese dioxide, lithium sulfur, lithium titanate, nickel metal hydride, nickel cadmium, nickel hydrogen, nickel iron, sodium sulfur, vanadium redox, lead acid, or combinations thereof.

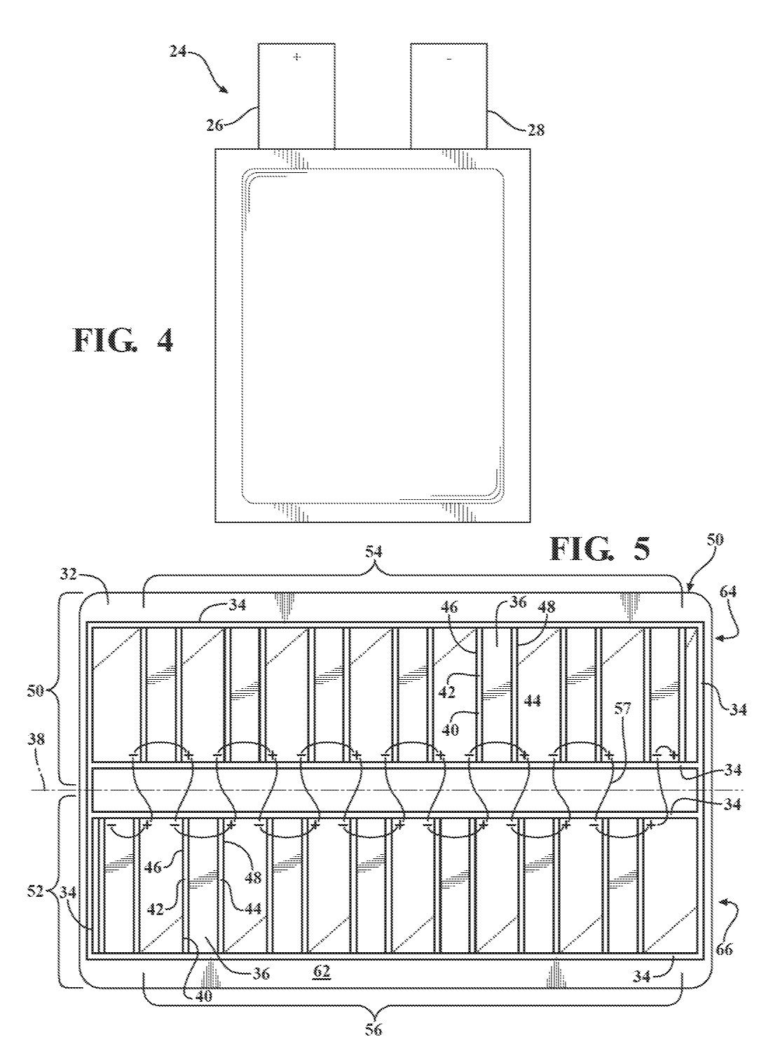

Referring to FIG. 4, each electrochemical battery cell 24 has a positive cell tab 26 and a negative cell tab 28. The electrochemical battery cell 24 may be suitable for stacking. That is, the electrochemical battery cell 24 may be formed from a heat-sealable, flexible foil that is sealed to enclose a cathode, an anode, and a separator (not shown). Therefore, any number of electrochemical battery cells 24 may be stacked or otherwise placed adjacent to each other to form a cell stack, i.e., the battery module 20 (FIG. 1). Further, although not shown in FIG. 1, additional layers, such as, but not limited to, frames and/or cooling layers may also be positioned between individual electrochemical battery cells 24. Consequently, the battery module 20 may include a plurality of positive cell tabs 26 and a plurality of negative cell tabs 28. The actual number of electrochemical battery cells 24 may be expected to vary with the required voltage output of each battery module 20. Likewise, the number of interconnected battery modules 20 may vary to produce the necessary total output voltage and output current capacity for a specific application.

The positive cell tabs 26 and the negative cell tabs 28 are electrode extensions that are internally welded to various cathodes and anodes (not shown) of the electrochemical battery cells 24, as is understood by one of ordinary skill in the art. The positive cell tabs 26 and the negative cell tabs 28 may be constructed of a conductive metal. For example, the positive cell tabs 26 may be constructed substantially of aluminum, and the negative cell tabs 28 may be constructed substantially of copper.

Referring to FIGS. 2, 3 and 5, each battery module 20 includes an interconnecting member 30. The interconnecting member 30 is coupled to each of the electrochemical battery cells 24. The interconnecting member 30 is configured for electrically connecting all of the positive cell tabs 26 and all of the negative cell tabs 28 in a desired configuration or sequence.

Referring to FIGS. 3 and 5, the interconnecting member 30 includes a substrate 32. The substrate 32 is electrically non-conductive. The substrate 32 may include and be manufactured from an electrically non-conductive material such as a plastic or other similar material. As shown in FIG. 5, the substrate 32 may include one or more geometric stiffening elements 34 to reduce flexure of the substrate 32. The stiffening elements 34 may include ridges and/or a perimeter rim having a thickened cross section to increase the resistance to bending and/or flexing. It should be appreciated that the stiffening elements 34 may include any geometric feature added to and/or formed into the substrate 32 to improve the bending strength of the substrate 32.

Referring to FIG. 5, the substrate 32 supports a plurality of connecting elements 36. The connecting elements 36 include a flat bar shaped electrical conductor having an approximately rectangular cross section parallel with a central longitudinal axis 38 of the interconnecting member 30. As shown, the connecting elements 36 are arranged in a co-planar relationship relative to each other. However, it should be appreciated that the connecting elements 36 may alternatively be arranged in a non co-planar relationship. Preferably, the connecting elements 36 include and are manufactured from copper. However, it should be appreciated that the connecting elements 36 may be manufactured from some other electrically conductive material. The connecting elements 36 may be electrically connected to each other through various electrical jumpers (not shown) formed into and/or supported by the substrate 32. The substrate 32 defines a plurality of openings 40. One of the connecting elements 36 is positioned within each of the openings 40. Each of the connecting elements 36 is positioned within a respective opening to define a first slot 42 disposed on one side of the planar conducting element and a second slot 44 disposed on an opposite side of the connecting element 36. More specifically, the first slots 42 are defined between a first edge 46 of each of the openings 40 and the respective connecting element 36 disposed within each opening, and the second slots 44 are defined between a second edge 48 of each of the openings 40 and the respective connecting element 36 disposed within each opening.

The central longitudinal axis 38 longitudinally divides the interconnecting member 30 into a first half 50, i.e., an upper longitudinal half of the interconnecting member 30 as shown in FIG. 5, and a second half 52, i.e., a lower longitudinal half of the interconnecting member 30 as shown in FIG. 5. The plurality of connecting elements 36 are arranged to include a first group 54 of connecting elements 36 disposed on the first half 50 of the interconnecting member 30, and a second group 56 of connecting elements 36, disposed on the second half 52 of the interconnecting member 30. Each of the connecting elements 36 is oriented approximately perpendicularly relative to the central longitudinal axis 38, with each of the positive cell tabs 26 and the negative cell tabs 28 of each of the electrochemical battery cells 24 also oriented approximately perpendicular relative to the central longitudinal axis 38 of the interconnecting member 30.

As shown in FIG. 5, the connecting elements 36 of the first group 54 of connecting elements 36 are staggered with the connecting elements 36 of the second group 56 of connecting elements along the central longitudinal axis 38. As such, moving axially along the central longitudinal axis 38, each of the connecting elements 36 of the first group 54 of connecting elements 36 is positioned at a different axial location than any of the connecting elements 36 of the second group 56 of connecting elements 36. This staggered orientation provides for a connection sequence described in greater detail below.

Referring to FIG. 3, at least one positive cell tab 26 or one negative cell tab 28 extends through each of the first slots 42 and the second slots 44 adjacent each of the connecting elements 36. As shown in FIG. 2, the electrochemical battery cells 24 are stacked relative to each other so that three positive cell tabs 26 are aligned in a row adjacent each other, with three negative cell tabs 28 aligned in the same row adjacent each other and opposite the three adjacent positive cell tabs 26. As shown in FIG. 2, the three positive cell tabs 26 extend through the first slot 42, and the three negative cell tabs 28 extend through the second slot 44. The three positive cell tabs 26 and the three negative cell tabs 28 are electrically connected to the connecting element 36 as described in greater detail below. Referring to FIG. 5, the electrochemical battery cells 24 may be arranged in groups of three with the relative positions of the positive cell tabs 26 and the negative cell tabs 28 alternating with each sequentially positioned group of three electrochemical battery cells 24 along the central longitudinal axis 38. This relative positioning of the electrochemical battery cells 24 defines the connection sequence. As such, an electric current may flow from the three positive cell tabs 26 across one of the connecting elements 36 in the first group 54 of connecting elements 36 to the three opposing negative cell tabs 28, then flow through the electrochemical battery cells 24 and across the longitudinal axis to the corresponding three positive cell tabs 26, and across one of the connecting elements 36 in the second group 56 of connecting elements 36. The electric current may flow in a sinusoidal or zig-zag path, such as shown in FIG. 5 at 57, to define the connection sequence of the battery module 20. It should be appreciated that the electrochemical battery cells 24, and more specifically the positive cell tabs 26 and the negative cell tabs 28 may be arranged differently than shown and described herein, with more or less than the three cell tabs 26, 28 extending through each of the slots 42, 44.

Referring to FIG. 3, each of the cells tabs, either the positive cell tabs 26 or the negative cell tabs 28, extend through one of the slots 42, 44, either a first slot 42 or a second slot 44, and are formed into a parallel relationship relative to the connecting element 36 adjacent thereto. At least one of a plurality of fastening mechanisms 58 connect the positive cell tabs 26 and the negative cell tabs 28 to one of the connecting elements 36. The plurality of electrochemical battery cells 24 are disposed adjacent a first surface 60, i.e., a lower surface, of the interconnecting member 30. The fastening mechanisms 58 are configured for engaging the positive cell tabs 26 and the negative cell tabs 28 from a second surface 62 of the interconnecting member 30 only, i.e., an upper surface. The second surface 62 is opposite the first surface 60. As such, fastening machinery need only have access to the second surface 62 of the interconnecting member 30 to engage the fastening mechanism 58. The fastening mechanisms 58 may include but are not limited to a mechanical fastener such as a rivet, a screw, a bolt, a clip or some other similar mechanical fastening device. Alternatively, the fastening mechanism 58 may include a welded connection or some other fusion type of connection mechanism.

Preferably, each of the cell tabs 26, 28 extending through the first slots 42 are formed to overlap in a parallel relationship with the cell tabs 26, 28 extending through the second slots 44, with one of the plurality of fastening mechanisms 58 simultaneously connecting both the positive cell tabs 26 and the negative cell tabs 28 extending through the first slots 42 and the second slots 44 to the connecting element 36. For example, referring to FIGS. 2 and 3, the positive cell tabs 26 of three electrochemical battery cells 24 are joined in overlapping engagement to the negative cell tabs 28 of three other electrochemical battery cells 24. As shown in FIGS. 2 and 3, the positive cell tabs 26 are bent at a substantially 90 degree angle relative to the connecting element 36 so as to extend over and contact the negative cell tabs 28, which are also bent at a substantially 90 degree angel relative to the connecting element 36. By overlapping the positive cell tabs 26 with the negative cell tabs 28 and joining both to a single connecting element 36, the total number of fastening mechanisms 58 and connections to the connecting elements 36 is minimized, thereby reducing manufacturing costs.

A method of manufacturing the battery module 20 is also provided. The method includes stacking the electrochemical battery cells 24 adjacent each other in any desirable manner suitable to achieve the desired connection configuration. For example and as shown in FIG. 5, the electrochemical battery cells 24 may be stacked to define a first row 64 of cell tabs 26, 28 disposed on the first half 50 of the interconnecting member 30 and a second row 66 of cell tabs 26, 28 disposed on the second half 52 of the interconnecting member 30, with each of the first row 64 and second row 66 of cell tabs 26, 28 including sets of three cell tabs 26, 28 alternating between positive cell tabs 26 and negative cell tabs 28, i.e., each row of cell tabs 26, 28 includes three positive cell tabs 26, followed by three negative cell tabs 28, followed by three positive cell tabs 26, etc.

Once the electrochemical battery cells 24 are stacked relative to each other, then the interconnecting member 30 is positioned adjacent the stacked electrochemical battery cells 24 so that each of the positive cell tabs 26 and each of the negative cell tabs 28 extend through one of the first slot 42 or the second slot 44 disposed adjacent one of the plurality of connecting elements 36. The cell tabs 26, 28 are then formed or bent until approximately parallel with and adjacent to the connecting element 36 disposed adjacent the slot through which each tab extends through. Preferably, the cell tabs 26, 28 extending through the first slots 42 are formed to overlap in a parallel relationship with the cell tabs 26, 28 extending through the associated second slots 44, across a common connecting element 36.

Once the cell tabs 26, 28 are formed or bent to be substantially parallel with their associated connecting element 36, the cell tabs 26, 28 are then fastened to their respective connecting element 36. As described above, the cell tabs 26, 28 may be mechanically fastened with a rivet, a screw, a bolt, a clip or some other similar mechanical fastening device, or may be fused together, for example, with a welded connection. The cell tabs 26, 28 are fastened to the connecting elements 36 from an upper vertical side of the interconnecting member 30, opposite the stacked electrochemical battery cells 24, such that any fastening tooling need not be positioned underneath the interconnecting member 30.

While the best modes for carrying out the invention have been described in detail, those familiar with the art to which this invention relates will recognize various alternative designs and embodiments for practicing the invention within the scope of the appended claims.

1. A battery module comprising:
a plurality of electrochemical battery cells positioned adjacent each other, with each of the electrochemical battery cells including a positive cell tab and a negative cell tab;
an interconnecting member coupled to each of the electrochemical battery cells and configured for electrically connecting all of the positive cell tabs, and for electrically connecting all of the negative cell tabs;
wherein the interconnecting member includes a plurality of connecting elements and defines a first slot and a second slot disposed adjacent opposing sides of each connecting element;
wherein at least one positive cell tab or one negative cell tab extends through each of the first slots and the second slots and is formed into a parallel relationship relative to the connecting element adjacent thereto; and
a plurality of fastening mechanisms connecting the positive cell tabs and the negative cell tabs to one of the connecting elements.

2. A battery module as set forth in claim 1 wherein the plurality of connecting elements include a first group of connecting elements and a second group of connecting elements.

3. A battery module as set forth in claim 2 wherein the interconnecting member defines a central longitudinal axis longitudinally dividing the interconnecting member into a first half and a second half, with the first group of connecting elements disposed on the first half of the interconnecting member, and the second group of connecting elements disposed on the second half of the interconnecting member.

4. A battery module as set forth in claim 3 wherein the first group of connecting elements are staggered relative to the second group of connecting elements along the central longitudinal axis.

5. A battery module as set forth in claim 3 wherein each of the connecting elements are oriented approximately perpendicularly relative to the central longitudinal axis.

6. A battery module as set forth in claim 5 wherein each of the positive cell tabs and the negative cell tabs of each of the electrochemical battery cells are oriented approximately perpendicular relative to the central longitudinal axis of the interconnecting member.

7. A battery module as set forth in claim 1 wherein the interconnecting member includes a substrate supporting the plurality of connecting elements.

8. A battery module as set forth in claim 7 wherein the substrate is electrically non-conductive.

9. A battery module as set forth in claim 8 wherein the substrate includes stiffening elements to reduce flexure of the substrate.

10. A battery module as set forth in claim 8 wherein the substrate defines a plurality of openings, with one of the connecting elements positioned within each of the openings to define the first slots between a first edge of the openings and the connecting elements and to define the second slots between a second edge of the openings and the connecting elements.

11. A battery module as set forth in claim 1 wherein each of the cell tabs extending through the first slots are formed to overlap in parallel relationship with the cell tabs extending through the second slots, with at least one of the plurality of fastening mechanisms connecting both the cell tabs extending through the first slots and the second slots to the connecting element.

12. A battery module as set forth in claim 1 wherein the plurality of electrochemical battery cells are disposed adjacent a first surface of the interconnecting member, with the fastening mechanisms configured for engaging the positive cell tabs and the negative cell tabs from a second surface of the interconnecting member, wherein the second surface is opposite the first surface.

13. A battery module as set forth in claim 11 wherein the fastening mechanism includes one of a rivet, a screw, a clip, a bolt or a weld.

14. A battery module as set forth in claim 1 wherein the connecting elements include copper elements.

15. A method of manufacturing a battery module, the method comprising:
stacking a plurality of electrochemical battery cells adjacent each other, wherein each of the electrochemical battery cells include a positive cell tab and a negative cell tab;
positioning an interconnecting member adjacent the stacked electrochemical battery cells so that each of the positive cell tabs and each of the negative cell tabs extend through one of a first slot or a second slot disposed adjacent one of a plurality of connecting elements;
forming each of the cell tabs until approximately parallel with and adjacent to the connecting element disposed adjacent the slot through which each tab is extends; and
fastening each of the positive cell tabs and the negative cell tabs to one of the connecting elements.

16. A method as set forth in claim 15 wherein fastening each of the positive cell tabs and the negative cell tabs includes fastening with one of a rivet, a screw, a bolt, a clip or a weld.

17. A method as set forth in claim 15 wherein forming each of the cell tabs includes forming the cell tabs extending through the first slots to overlap in a parallel relationship with the cell tabs extending through the associated second slots.

18. A method as set forth in claim 15 wherein stacking the plurality of electrochemical battery cells adjacent each other is further defined as stacking each of the electrochemical battery cells to define a first row of cell tabs disposed on a first half of the interconnecting member and a second row of cell tabs disposed on a second half of the interconnecting member, with each of the first row and second row of cell tabs including sets of three cell tabs alternating between positive cell tabs and negative cell tabs
